(19) United States
(12) Patent Application Publication
(10) Pub. No.: US 2018/0232832 A1
(43) Pub. Date: Aug. 16, 2018

(54) Computerized System for Dynamic Determinations of Service Charges Involving Multiple Payers and Multiple Providers

(71) Applicant: Brighter, Inc., Santa Monica, CA (US)

(72) Inventor: Jason Szczuka, Santa Monica, CA (US)

(21) Appl. No.: 15/429,534

(22) Filed: Feb. 10, 2017

(51) Int. Cl. G06Q 50/22; G06Q 30/02

(52) U.S. Cl. CPC G06Q 50/22; G06Q 30/0283

(57) ABSTRACT

A system and method includes receiving, at a computing device, healthcare plan information and healthcare provider prices for a plurality of patient services; determining, at the computing device, a likelihood of selection of patient services by a patient; identifying, at the computing device, scenarios that result in a lowering of healthcare provider prices to increase the likelihood of selection by the patient based on the received healthcare plan, the received healthcare provider prices, and input at the computing device; and communicating, from the computing device, the identified scenarios and adjusted prices in a format configured for presentation at a patient device.

### BACKGROUND

The prices for services that healthcare providers make available to patients, via their health benefit plan, are created offline and result in a singular price for a given service for all patients from said plan. These prices are frequently higher than many providers would have offered had they been able to set their prices utilizing the aggregated volume and cost efficiencies from patients utilizing an online marketplace to research, select and communicate with their healthcare providers.

### SUMMARY

An illustrative method described in the present disclosure involves a computerized system for dynamic determinations of rules-based service charges by healthcare providers utilizing analytics and cost efficiencies from patients that will have access to the resulting service charges. The method includes receiving, at a computing device, healthcare plan information and healthcare provider prices for a plurality of patient services; determining, at the computing device, a likelihood of selection of patient services by a patient; identifying, at the computing device, scenarios that result in a lowering of healthcare provider prices to increase the likelihood of selection by the patient based on the received healthcare plan, the received healthcare provider prices, and input at the computing device; and communicating, from the computing device, the identified scenarios and adjusted prices in a format configured for presentation at a patient device.

An illustrative system includes a database, a computer service, and a communication interface. The database contains provider-specific pricing rules for a plurality of patient services and healthcare plan information for a plurality of healthcare plans. The computer server is coupled to the database and contains programmed instructions to determine a likelihood of selection of a healthcare provider for a patient service by a patient. The communication interface is coupled to the computer server and is configured for access by a healthcare provider computer and a patient computer. The computer server is configured to identify scenarios that result in a lowering of healthcare provider prices to increase the likelihood of selection by the patient responsive to information received from the healthcare provider computer and the patient computer.

An illustrative non-transitory computer readable medium has instructions stored thereon that, upon execution by a computing device, cause the computing device to perform operations. The instructions include instructions to receive healthcare plan information and healthcare provider prices for a plurality of patient services; instructions to determine a likelihood of selection of patient services by a patient; instructions to identify scenarios that result in a lowering of healthcare provider prices to increase the likelihood of selection by the patient based on the received healthcare plan, the received healthcare provider prices, and input at the computing device; and instructions to communicate the identified scenarios and adjusted prices in a format configured for presentation at a patient device.

### BRIEF DESCRIPTION OF THE DRAWINGS

Illustrative embodiments will hereafter be described with reference to the accompanying drawings.

FIG. 1 is a diagram illustrating a computerized system for dynamic determinations of service charges involving multiple payers and multiple providers in accordance with an illustrative embodiment.

FIG. 2 is a flow diagram illustrating a method for making dynamic determinations of service charges involving multiple payers and multiple providers in accordance with an illustrative embodiment.

FIG. 3 is a diagram illustrating a system configured to present dynamic pricing offers for service charges involving multiple payers and multiple providers in accordance with an illustrative embodiment

FIG. 4 is a flow diagram illustrating a method for presenting dynamic pricing offers for service charges in accordance with an illustrative embodiment.

FIG. 5 is a flow diagram illustrating a method for marketplace analytics that a provider would set rules against as an owner in accordance with an illustrative embodiment.

FIG. 6 is a block diagram illustrating a computing device in accordance with an illustrative embodiment.

### DETAILED DESCRIPTION

Described herein are illustrative embodiments for methods and systems for a computer system that provides faster, more relevant and actionable data based on analytics associated with service providers and service receivers. In particular, the illustrative embodiments involve a computerized system for dynamic determinations of service charges involving multiple payers and multiple providers. By way of example, the computer system described in the embodiments can be applied to a healthcare environment which includes health insurance companies, healthcare providers, and patients (both insured and uninsured). The embodiments contemplate implementations in other industries outside of healthcare.

The systems and methods disclosed herein can use various communication devices and protocols. The systems and methods are not limited to a particular provider or payer. For example, the system platform enables a variety of different payers, such as health insurance companies, and providers to benefit from the systems and methods despite different formatting and communication requirements.

Advantageously, the systems and methods described herein present a new computerized environment in which healthcare providers can set prices for their services utilizing efficiencies and analytics that enable them to reduce the cost of healthcare for many patients. Unlike previous systems and methods, those disclosed herein enable healthcare providers to reduce their business expenses by directly connecting with populations of patients, marketing their services to them and maintaining ongoing communications with them. In turn, these systems and methods create opportunities for the healthcare provider to identify patient scenarios in which the healthcare provider would be willing to reduce the price of their services in order to increase the likelihood of being selected by the patient. The systems and methods disclosed both highlight the reduced price to patients within these applicable scenarios that they apply to as well as ensure the plan processes said reduced price when the scenario applies. These scenarios can include, but are not limited to: total volume of patients using the marketplace, prices set by competing healthcare providers, whether the patient is a new patient for the healthcare provider, number of family members connected to the patient's plan, actions taken by the patient to maintain their health, appointment frequency of the patient, etc.

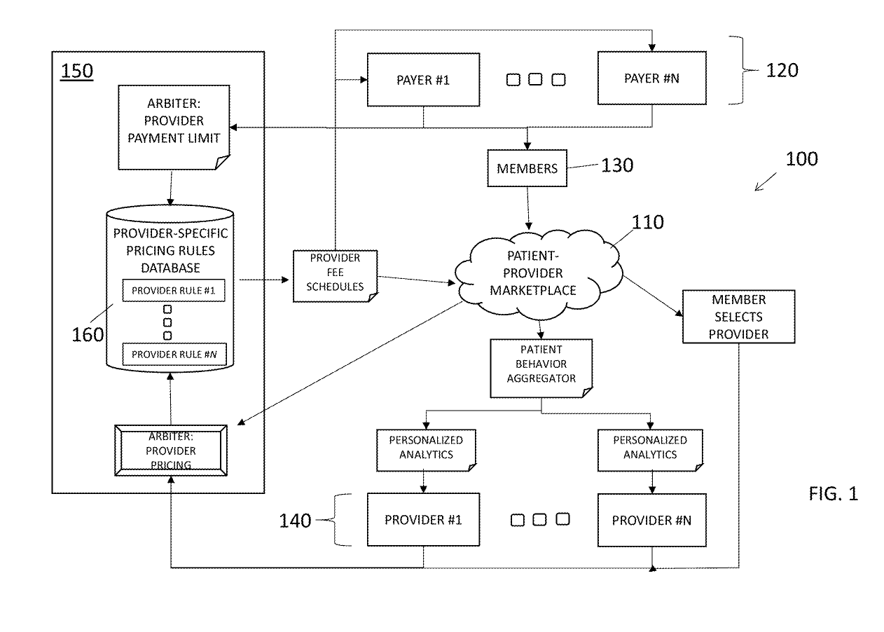

FIG. 1 is a diagram illustrating a system 100 for providing dynamic determinations of service charges involving multiple payers and multiple providers in accordance with an illustrative embodiment. The system 100 includes a cloud-based patient provider marketplace 110 configured to communicate with payers 120, members 130, and providers 140. The cloud-based marketplace 110 also communicates with an arbiter computer system 150. The arbiter computer system 150 includes a provider-specific pricing rules database 160. In alternative embodiments, fewer, additional, and/or different devices and services may be used.

According to one embodiment, system 100 makes dynamic determinations by having health insurance companies (payers 120) input into the arbiter computer system 150 an amount already agreed to with doctors (providers 140) for the highest amount the doctor will be paid for a service provided to members 130 of the payer. Payers 120 communicate a payment limit to the arbiter computer 150 that restricts the amount payers 120 are willing to pay for particular services.

In the system 100, providers 140 utilize personalized analytics on patient behaviors to set discounting rules in the arbiter computer system 150. For example, providers 140 can reduce their prices in a variety of scenarios, including based on: total volume of patients using the marketplace, prices set by competing healthcare providers, whether the patient is a new patient for the healthcare provider, number of family members connected to the patient's plan who are more likely to also become a patient of the healthcare provider, actions taken by the patient to maintain their health, appointment frequency of the patient, etc. As another example, providers 140 may provide patients with wearable technology devices that track heart rate, movement, numbers of steps taken, numbers of stairs climbed, sleep habits, and many other different behaviors. The wearable technology devices may be communicatively coupled to a server or other computing system of the providers 140, the arbiter computer system 150 or the patient provider marketplace 110 and may be configured to periodically provide health information about patients for use in setting discounting rules or determining price proposals.

Personalized analytics can perform multiple functions, including alerting a healthcare provider of patient volume and activities within their local markets.

A payer's member 130 uses the cloud-based marketplace 110 to compare local doctors and generates a real time request for prices from the arbiter computer system 150. In an example embodiment, the member 130 uses a personal computer or a mobile computing device to access the cloud-based marketplace 110 via the Internet. The communication between member 130 and the cloud-based marketplace 110 preferably includes a secure log in procedure to limit access of patient data to only the patient or people with permission from the patient. The member 130 can review provider statistics, prices, reviews, and other details to make a decision on what provider to see. In alternative embodiments, different plan members access the cloud-based marketplace 110 using different hosted solutions.

In an example embodiment, the arbiter computer system 150 performs an unattended application of the pricing rules set by both the applicable payer and provider pool. The pricing rules draw on a variety of different metrics including diagnostic information and personalized analytics. Different providers may have different pricing rules. The arbiter computer system 150 automatically applies pricing rules in combination with patient information to generate dynamic prices.

The arbiter computer system 150 generates the resulting provider prices in the form of provider fee schedules and communicates them back to the member via the cloud-based marketplace 110. The provider fee schedules can be specific to particular patients or specific to different patient groups depending on the provider and the rules they set. An applicable provider fee schedule 170 is sent to the payer 120 for claim payment if the member 130 accepts the price, receives the service and a claim is submitted for payment to the provider for the service. In some embodiments, the provider submits the claim themselves. The member 130 can review the prices in the provider fee schedule 170 using the cloud-based marketplace 110.

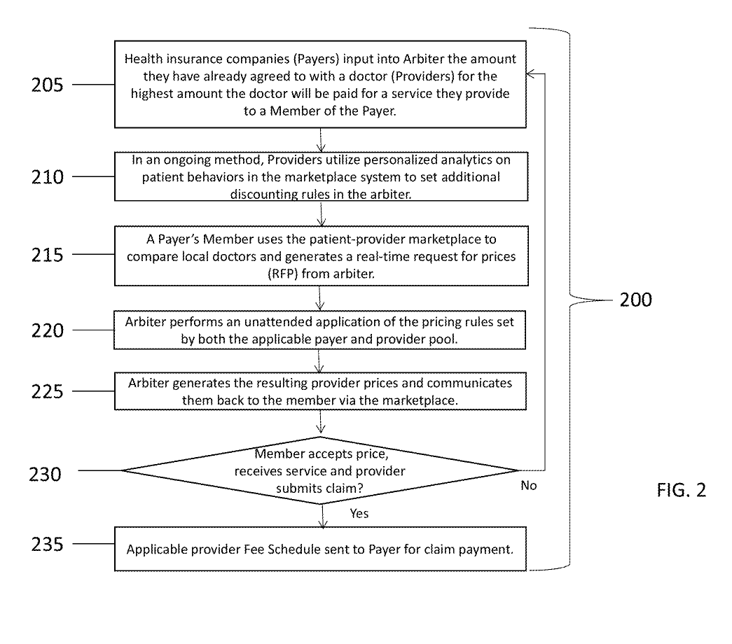

FIG. 2 is a flow diagram illustrating a method 200 for providing dynamic determinations of service charges involving multiple payers and multiple providers in accordance with an illustrative embodiment. In alternative embodiments, fewer, additional, and/or different operations may be performed. Also, the use of a flow diagram is not meant to be limiting with respect to the order of operations performed. The method 200 may be done, for example, using the devices and connections shown in the system 100 and described above with respect to FIG. 1. In other embodiments, different devices/systems may be used.

In an operation 205, health insurance companies input into an arbiter computer system the amount they have already agreed to with a doctor (or other healthcare provider) for the highest amount the doctor will be paid for a service provided to a member (the insured) regardless of any other factors. The input may include additional information beyond an amount for a particular service. The health insurance company may include discounts or other healthcare provider incentives.

In an operation 210, providers utilize personalized analytics of aggregated and de-identified patient behaviors tracked by the marketplace system to set additional discounting rules in the arbiter computer system. Marketplace analytics can track a number of metrics important to the provider, including the number of patients they are currently not highlighted to due to their prices compared to their local competitors. The analytics can be aggregated daily, weekly, or over any time period. In some embodiments, the analytics can be captured and computed in real-time.

In an operation 215, a payer's member uses the patient-provider marketplace to compare local doctors and generates a real-time request for prices (RFP) from the arbiter computer system. The comparison function can include providing a list of services and fees for a number of providers in a particular geographic area. The comparison function can also include providing a list of providers within a healthcare network and the fees within a network. The comparison function can also include reviews and feedback related to the different providers based on past patient comments.

In an operation 220, the arbiter computer system performs an unattended application of the pricing rules set by both the applicable payer and provider pool. The unattended aspect of the application of pricing rules refers to the automated feature of the pricing rule engine. As a number of factors used to calculate prices are continually changing, the pricing rules are continually being updated and changed. Moreover, the pricing rules take into account more variables that are continually varying than a human being could feasibly account for if computing the prices manually.

In an operation 225, the arbiter computer system generates the resulting provider prices and communicates them back to the member via the marketplace system. The arbiter computer system provides the prices to the marketplace system for the member to review and select a provider from. In an alternative embodiment, the provider has access to the provider prices and may be able to adjust charges and fees to be able to competitively price the services compared to other providers.

In an operation 230, a determination is made whether the member accepts the price, receives the service, and the provider submits the claim. In some embodiments, the price may include an expiration term that limits the time period during which the price is valid. The price may also, in some embodiments, be affected by appointment times and dates. For example, a provider may offer discounted pricing for mid-day appointments or for unpopular days of the week, such as Monday. In other embodiments, providers may adapt pricing based on the volume of appointments or if the patient is new to their practice. Providers may increase pricing, by adjusting their specific rules, with increased number of appointments from patients.

If the price is accepted and the service rendered, an operation 235 is performed in which an applicable provider fee schedule is sent to the appropriate payer for claim payment.

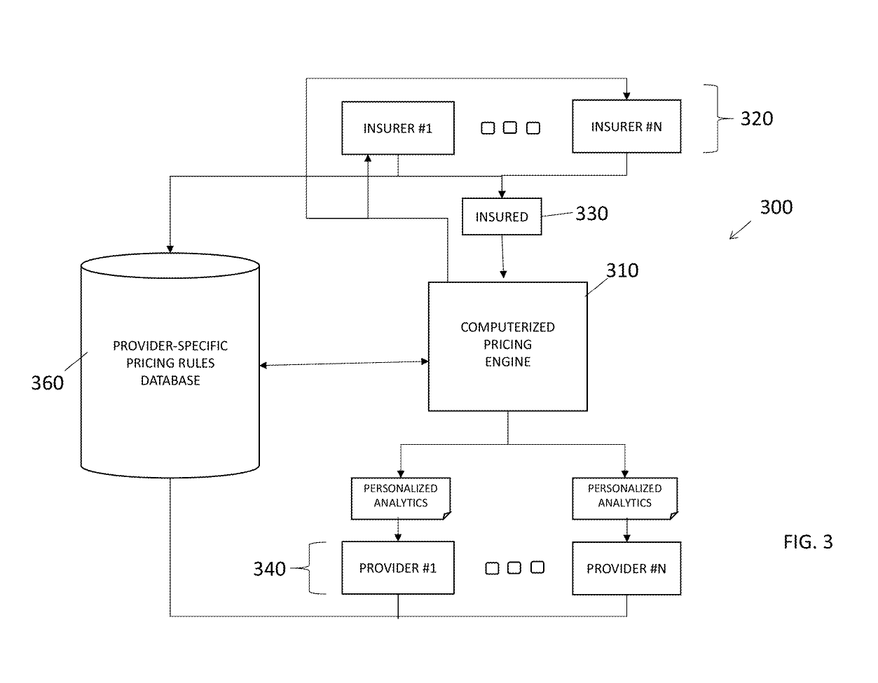

FIG. 3 is a diagram illustrating a system 300 configured to present dynamic pricing offers for service charges involving multiple payers and multiple providers in accordance with an illustrative embodiment. The system 300 includes a computerized pricing engine 310 configured to communicate with healthcare insurers 320, healthcare insured 330, and healthcare providers 340. Healthcare insurers 320 and healthcare providers 340 can provide data to a provider-specific pricing rules database 360. The computerized pricing engine 310 communicates with the specific pricing rules database 360 to gather and store information relative to the determination of dynamic pricing offers.

Although the system 300 is described in the context of the healthcare industry, the computerized pricing engine 310 can be used in a variety of industries. In alternative embodiments, fewer, additional, and/or different devices and services may be used.

In at least one embodiment, healthcare providers 340 provide appointment scheduling information to the computerized pricing engine 310. Such information can be provided using interfaces with electronic health record management software. Appointment scheduling information from healthcare providers 340 can include information about variable discounts depending on the time of day or day of the week an appointment is scheduled. Advantageously, such pricing enables healthcare providers 340 the ability to offer discounts for patients scheduling visits at unpopular times or days. For example, one particular provider may include a clientele that prefers early morning appointments or weekend appointments. Instead of having a large backlog of appointments in the morning or on the weekends, the computerized pricing engine 310 enables the providers 340 to offer lower prices for appointments made at slower times and days.

The computerized pricing engine 310 enables healthcare insurers 320 and healthcare 340 to present pricing options based on personalized analytics, insurance policy parameters, healthcare provider needs, and other data relevant to pricing a service. In at least another embodiment, the dynamic pricing generated by the computerized pricing engine 310 includes a timing aspect where the pricing schedules are valid until a certain determined expiration date. The expiration data may change for different insured patients and may vary depending on service data.

The computerized pricing engine 310 provides transparency, flexibility and efficiency to healthcare service pricing heretofore unavailable. Advantageously, the insured 330 can access the computerized pricing engine 310 over a computer network such as the Internet to be able to compare and contrast pricing and services available at different providers 340 based on both the healthcare plan of the insured and the populations of patients using the pricing engine. The computerized pricing engine 310 includes programmed instructions to enable the calculation of service pricing based on multivariable factors. In an example implementation, the more family members the insured has that are also part of the plan, the less costly the healthcare services will be priced at as it is more advantageous for the healthcare provider to reduce their prices for the insured as a manner to cost-effectively attract their family members as well. Providers 340 provide specific pricing rules based on patient populations using the Marketplace as well as the healthcare insurance payment rules.

By way of example, providers may reduce their prices in a variety of scenarios, including: total volume of patients using the marketplace, prices set by competing healthcare providers, whether the patient is a new patient for the healthcare provider, number of family members connected to the patient's plan who are more likely to also become a patient of the healthcare provider, actions taken by the patient to maintain their health, appointment frequency of the patient, etc. The patient scenarios incorporate a variety of factors and consumer analytics to calculate the likelihood of a patient selecting a specific provider should the respective provider offer an additional discount such as the volume of positive patient reviews the provider has received, the substantiveness of the provider's professional history (e.g. license history, advanced training, etc.), the proximity of the provider to the systems patient population, and the specific searching patient's dental history (e.g. how likely are they to select a new dentist or doctor).

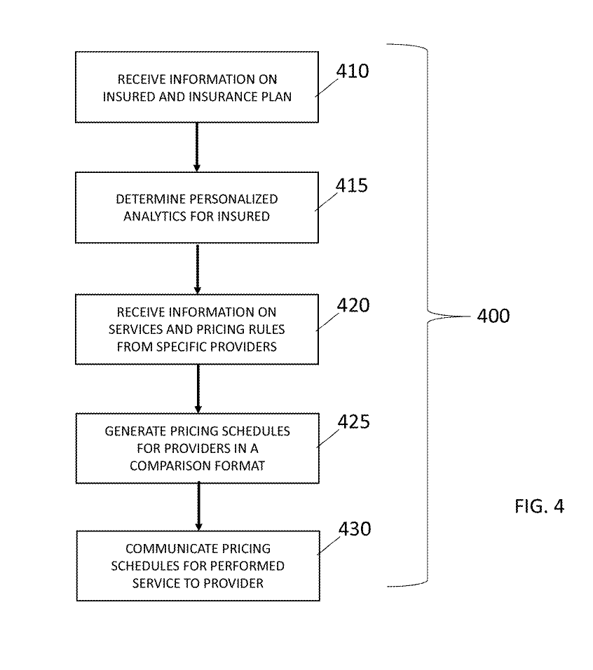

FIG. 4 is a flow diagram illustrating a method 400 for presenting dynamic pricing offers for service charges in accordance with an illustrative embodiment. In alternative embodiments, fewer, additional, and/or different operations may be performed. Also, the use of a flow diagram is not meant to be limiting with respect to the order of operations performed. The method 400 may be done, for example using the devices and connections shown in the system 300 and described above with respect to FIG. 3. In other embodiments, different devices/systems may be used.

In an operation 410, a computerized pricing engine receives information on insured members and insurance plans from healthcare insurers. Such information can be communicated over private networks or over public networks using encryption or other security means. The information is provided in a format standard to communication of healthcare information and in accordance with governing laws and regulations.

In an operation 415, the computerized pricing engine determines personalized analytics for insured persons based on information gathered from activity tracking devices. The information can include heart rate, blood pressure, physical activity, glucose levels, and a variety of other different physiological functions. The information can be communicated directly from monitoring devices, such as wearable devices, or the information can be communicated from computing devices receiving the information via a synchronization operation with a tracking device.

In an operation 420, the computerized pricing engine receives information on services and pricing rules from specific healthcare providers. The services information can include names and descriptions of services as well as circumstances or conditions under which the services are provided. The pricing rules can include cost information for performance of the service, including breakdowns in the cost by components such as equipment fees, specialist fees, facility fees, medication fees, etc. The pricing fees, in some embodiments, can include discounts available based on certain personalized analytic metrics. The pricing fees can also include discounts or surcharges based on appointment times and dates.

In an operation 425, the computerized pricing engine generates pricing schedules for a particular insured person in a comparison format to enable the insured person to compare prices, services, and other considerations that may affect the decision of the insured person to use a particular service provider. The comparison format may be a table or an interactive menu listing or any other of a variety of user interfaces. While price is certainly an important factor, the system does not simply use price to determine who and how providers are shown to patients. Other factors such as the volume of positive patient reviews the provider has received, the substantiveness of the provider's professional history (e.g. license history, advanced training, etc.) and the proximity of the provider to the patient are included to display rank the providers to ensure the likelihood of the patient selecting one that they are completely satisfied with.

In an operation 425, the computerized pricing engine communicates a pricing schedule corresponding to a particular insured person that received a service from the provider. In some embodiments, the pricing schedule can be presented at admission of the patient before the service and, in other embodiments, the pricing schedule is presented after the service is performed during the billing process.

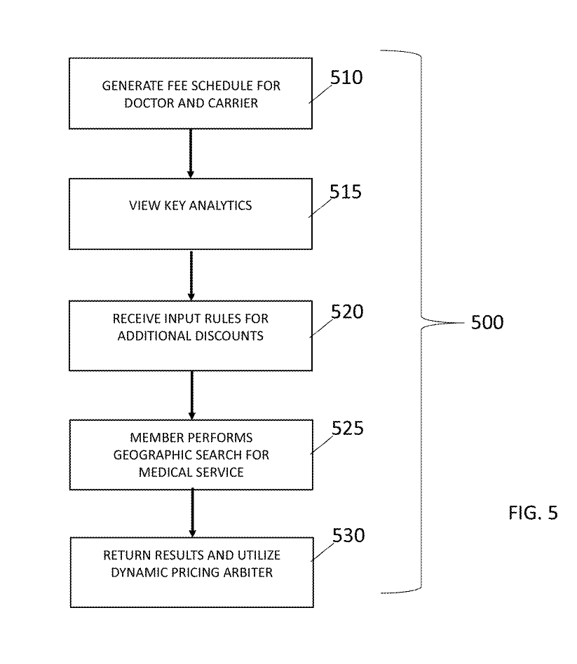

FIG. 5 is a flow diagram illustrating a method 500 for marketplace analytics that a provider would set rules against as an owner in accordance with an illustrative embodiment. In alternative embodiments, fewer, additional, and/or different operations may be performed. Also, the use of a flow diagram is not meant to be limiting with respect to the order of operations performed. The method 500 can be used to create and communicate healthcare PPO network prices with dynamic pricing.

In an operation 510, a carrier recruits a doctor to participate in its network and the carrier and the doctor negotiate a “fee schedule” (a list of all of the services that the doctor performs and what the doctor will be paid for them via the carrier). Resulting fee schedules are intended to be at a discount from the amount the doctor would otherwise charge to a patient that walked in off the street without insurance. The “discounts” by the doctor are in exchange for the carrier highlighting the doctor as “in network” with promotional support like being listed in their directory and smoother claims processing.

In an operation 515, a doctor can log into a provider portal to view key analytics of the aggregated member/patients that have access to the marketplace via their carriers (which, in addition to other things, shows the member what they will pay for each service at each network doctor). These new analytics that the doctor can see include, but are not limited to:

a. Total number of patients that use the marketplace

b. Total dollar amounts spent by these members annually

c. How many new patient visits (i.e. a new patient for a doctor) this population generates annually.

d. Breakdown of the actual services received by the population annually (e.g. 1,000,000 Comprehensive Exams, 3,000,000 X-Rays, etc)

e. Family demographics (Single, Couple, Couple w/Kids)

f. Services & provider types they search for the most

The doctor can also see analytics on how he or she is positioned to these members within the marketplace; including how they appear in Search Results and how much of the applicable business from this population they get today. In an operation 520, the doctor can then input rules for additional discounts he or she is willing to offer members that select them from the marketplace (and only these online members). These rules can include: additional discounts (e.g. percentage, absolute dollar amounts, etc) on all services; new patient specials; pricing specials based on family size (i.e. bigger families are easier to generate more business from); members that maintain their 6 month regular check-ups; and discounts for cosmetic services (not covered by the carrier).

In an operation 525, when a member goes into the marketplace, via their carrier, they can perform a geographic search with the service they are in need of. In an operation 530, the marketplace returns results with the prices for each doctor, based on the rules they set and their applicability to the searching member. For example, Dr. Hunter had agreed to a price of $150 for a New Patient Visit with Jason's carrier, but also put in a marketplace—New Patient Special of $99. Jason comes into the marketplace via his carrier's website and searches in Dr. Hunter's area for a New Patient Visit. The marketplace's dynamic pricing arbiter identifies that Jason would be a new patient at Dr. Hunter's and would therefore return a search result with Dr. Hunter's price for that service listed as $99 (if Jason would not have been a new patient at Dr. Hunter's the arbiter would have returned a result of $150). If the member had selected Dr. Hunter from a source other than the Marketplace (e.g. Google, phonebook, etc.), the plan would pay the $150. After the member has selected his or her doctor, received the service, and a claim has been submitted to the carrier, the arbiter confirms the claim and the adjusted price that is to be paid to the provider.

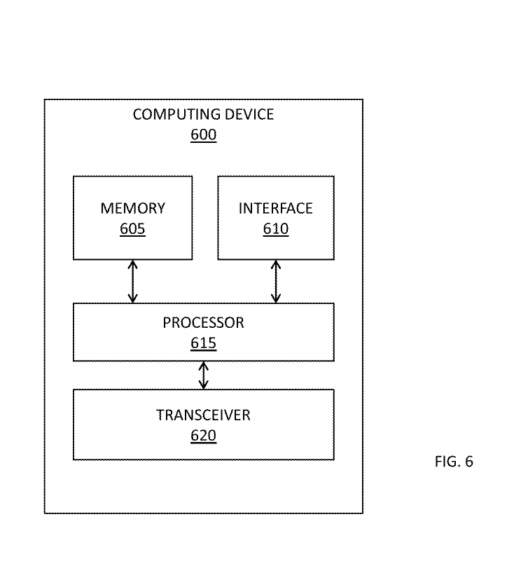

FIG. 6 is a block diagram illustrating a computing device 500 in accordance with an illustrative embodiment. In alternative embodiments, fewer, additional, and/or different components may be included in the computing device 600. The computing device 600 is shown merely as an example of the components of the various computing devices that may be used in the various embodiments disclosed herein. For example, the computing device 600 may be the cloud-based patient provider marketplace 610, the payer 620, the members 630, the providers 640, the arbiter computer system 650, the database 660, and any combination thereof.

The computing device 600 includes a processor 615 that is coupled to a memory 605. The processor 615 can store and recall data and applications in the memory 605. The processor 615 can execute sets of instructions stored on the memory. In one example, a set of instructions may be a mobile application (app). The memory 605 may store more than one app. Throughout the present application, if an app is referred to, it can mean a set of instructions stored on a memory that can be executed by a processor. In various embodiments, an app may be executed through a web browser; an application stored on a computing device such as a mobile phone, tablet, or laptop computer; etc. The processor 615 may also display objects, applications, data, etc. on an interface 610. A user may also interact with the computing device 600 through the interface 610.

The processor 615 is also coupled to a transceiver 620. The transceiver 620 includes hardware that allows the processor 615, using software stored on the memory 605, to communicate with other computing devices, for example through the internet, cellular networks, data networks, Wi-Fi networks, etc. The computing device 600 is merely one type physical system on which aspects of the disclosed embodiments may be executed. Other configurations of devices may also be used.

To operate different embodiments of the system or programs disclosed herein, the various devices may communicate in different ways. For example, the computing device 600 may download a software application, such as an app, from the internet. In another embodiment, computing device 600 may access an interface with the functionalities disclosed herein through a browser or virtual machine. Such software applications may allow the various devices in FIG. 1 to perform some or all of the processes, methods, and functions described herein. Additionally, the embodiments disclosed herein are not limited to being performed only on the disclosed devices in FIG. 1 or 3. Many various combinations of computing devices may execute the methods and systems disclosed herein. Examples of such computing devices may include desktop computers, cloud servers, smart phones, personal computers, servers, laptop computers, tablets, blackberries, RFID enabled devices, wearable electronic devices, or any combinations of such devices or similar devices.

In an illustrative embodiment, the operations described herein can be implemented at least in part as computer-readable instructions stored on a computer-readable medium or memory. Upon execution of the computer-readable instructions by a processor, the computer-readable instructions can cause a computing device to perform the operations.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A method according to a set of instructions stored on the memory of a computing device, the method comprising:
receiving, at a computing device, healthcare plan information and healthcare provider prices for a plurality of patient services;
determining, at the computing device, a likelihood of selection of patient services by a patient;
identifying, at the computing device, scenarios that result in a lowering of healthcare provider prices to increase the likelihood of selection by the patient based on the received healthcare plan, the received healthcare provider prices, and input at the computing device; and
communicating, from the computing device, the identified scenarios and adjusted prices in a format configured for presentation at a patient device.

2. The method of claim 1, further comprising receiving analytics corresponding to patient behavior.

3. The method of claim 1, further comprising receiving analytics corresponding to the plurality of patient services.

4. The method of claim 1, wherein determining the likelihood of selection of patient services by a patient includes comparing healthcare provider prices for a plurality of healthcare providers in a market associated with the patient and the healthcare provider.

5. The method of claim 1, wherein identifying scenarios that result in a lowering of healthcare provider prices include computed analytics including total volume of patients for the healthcare provider.

6. The method of claim 1, wherein identifying scenarios that result in a lowering of healthcare provider prices include computed analytics including prices set by competing healthcare providers.

7. The method of claim 1, wherein identifying scenarios that result in a lowering of healthcare provider prices include computed analytics including whether the patient is a new patient for the healthcare provider, number of family members connected to a patient plan, actions taken by the patient to maintain health, and appointment frequency of the patient.

8. The method claim 1, wherein healthcare providers cannot view prices of a plurality of healthcare providers in a market associated with the patient and the healthcare provider.

9. A system comprising:
a database containing provider-specific pricing rules for a plurality of patient services and healthcare plan information for a plurality of healthcare plans;
a computer server coupled to the database and containing programmed instructions to determine a likelihood of selection of a healthcare provider for a patient service by a patient; and
a communication interface coupled to the computer server and configured for access by a healthcare provider computer and a patient computer,
wherein the computer server is configured to identify scenarios that result in a lowering of healthcare provider prices to increase the likelihood of selection by the patient responsive to information received from the healthcare provider computer and the patient computer.

10. The system of claim 9, wherein the computer service receives analytics corresponding to the plurality of patient services.

11. The system of claim 9, wherein the computer server determines the likelihood of selection of patient services by a patient by comparing healthcare provider prices for a plurality of healthcare providers in a market associated with the patient and the healthcare provider.

12. The system of claim 9, wherein the computer server identifies scenarios that result in a lowering of healthcare provider prices using computed analytics including total volume of patients for the healthcare provider.

13. The system of claim 9, wherein the computer server identifies scenarios that result in a lowering of healthcare provider prices using computed analytics including prices set by competing healthcare providers.

14. The system of claim 9, wherein the computer server identifies scenarios that result in a lowering of healthcare provider prices using computed analytics including whether the patient is a new patient for the healthcare provider, number of family members connected to a patient plan, actions taken by the patient to maintain health, and appointment frequency of the patient.

15. A non-transitory computer readable medium having instructions stored thereon that, upon execution by a computing device, cause the computing device to perform operations, wherein the instructions comprise:
instructions to receive healthcare plan information and healthcare provider prices for a plurality of patient services;
instructions to determine a likelihood of selection of patient services by a patient;
instructions to identify scenarios that result in a lowering of healthcare provider prices to increase the likelihood of selection by the patient based on the received healthcare plan, the received healthcare provider prices, and input at the computing device; and
instructions to communicate the identified scenarios and adjusted prices in a format configured for presentation at a patient device.

16. The non-transitory computer readable medium of claim 15, wherein the instructions to determine the likelihood of selection of patient services by a patient includes instructions to compare healthcare provider prices for a plurality of healthcare providers in a market associated with the patient and the healthcare provider.

17. The non-transitory computer readable medium of claim 15, wherein the instructions to identify scenarios that result in a lowering of healthcare provider prices include computed analytics with total volume of patients for the healthcare provider.

18. The non-transitory computer readable medium of claim 15, wherein the instructions to identify scenarios that result in a lowering of healthcare provider prices include computed analytics with prices set by competing healthcare providers.

19. The non-transitory computer readable medium of claim 15, wherein the instructions to identify scenarios that result in a lowering of healthcare provider prices include computed analytics involving whether the patient is a new patient for the healthcare provider, number of family members connected to a patient plan, actions taken by the patient to maintain health, and appointment frequency of the patient.

20. The non-transitory computer readable medium claim 15, wherein healthcare providers cannot view prices of a plurality of healthcare providers in a market associated with the patient and the healthcare provider.
